(19) United States
(12) Patent Application Publication
(10) Pub. No.: US 2006/0149586 A1
(43) Pub. Date: Jul. 6, 2006

(54) Lodging attribute inventory

(76) Inventor: Terry M. Brown, Wichita, KS (US)

Correspondence Address: Bradley P. Sylvester, Suite 300, 200 North Broadway, Wichita, KS, 67202, US

(21) Appl. No.: 11/323,130

(22) Filed: Dec. 30, 2005

Related U.S. Application Data
(60) Provisional application No. 60/640,412, filed on Dec. 30, 2004.

(51) Int. Cl. G06Q 99/00; G05B 19/418; G06F 9/46

(52) U.S. Cl. 705/1; 235/382; 705/8

(57) ABSTRACT

A method of utilizing and inventorying variable attributes for rooms associated with Hotels and other similar services. A database comprising multiple data sets is compiled, where the data sets available may comprise any of the following: room availability; room attributes; attribute weight; and Guest weight. The attribute weight reflects the perceived value of the attributes for a particular room. The Guest weight reflects the perceived value of the Guest as a continued business relationship. The data sets are combined, with the information comprising an inventory of data that is similar to available assets. When a room is requested with certain attributes, higher weighted Guests will be given rooms with a higher weight, and lower weighted guests are matched with rooms having a lower attribute weight. The system can continuously shuffle all rooms, prior to the Guest actually checking in, so as to maximize Guest satisfaction and revenue to the Hotel.

This is a continuation in part of provisional application 60/640,412 (Lodging Attribute Inventory) filed Dec. 30, 2004.

No Federally sponsored research or development.

No incorporation-by-reference materials are included with this application.

### BACKGROUND OF THE INVENTION

Hotels and similar businesses have a limited number of rooms. The present invention relates generally to using a new business process method for ascertaining room availability for lodging facilities. The process incorporates a two-tiered architecture, which allows rooms to be placed in multiple categories and attributes so that the availability of any combination of attributes or single attribute may be viewed for any date range to determine availability. The process further includes the ability of various rooms and guests to be given variable weight within a desirability range, so as to maximize guest satisfaction and profit making abilities. The weight given represents value of the attributes to the room, or the perceived value of the guest to the User or Hotel.

### DESCRIPTION OF RELATED ART

The present invention as a business process is an extension of the traditional inventory mechanism, which has existed in automated lodging applications since such applications were created some 30 years ago, known often as a Room Type Inventory. The Room Type Inventory allows a lodging facility (hotel, motel, resort, camp, dorm, etc.) to view room availability based on a limited number of codes to represent “room types.” These types consist of such codes as King, Queen, Single, Double—representing bed types—but frequently are extended to allow a property to view other attributes of a room such as smoking status, ADA status (equipped for people with disabilities), and sometimes locations such as Poolside, High Floor, etc.

The Room Type Inventory mechanism was initially extremely limited due to constraints of database technology of the times. Most system vendors allowed a property to define up to ten codes. As database technologies advanced the industry began to demand additional functionality from system vendors.

The solution presented was “unlimited” room type codes. Thus, properties began to attempt to track inventory on many concatenations of room attributes. For example, a typical property might have created such codes as K, Q, S, D—to represent the bed types—and additional codes for the other attributes such as KNS—King Non-smoking, KS—King Smoking, KPS—King Poolside, KNPS—King Non-poolside, KNSPS—King Non-smoking Poolside, KSPS—King Smoking Poolside, etc.

For each new attribute a property decided to track in terms of inventory a code had to be created for every possible combination of all of the attributes. Thus, the mechanism quickly became cumbersome. As a result, today most properties have scaled back to tracking only a few attributes mainly pertaining to bed type. The rest of the things guests request are simply noted in a comment field and the guest is told that everything possible will be done to assure their requests are met.

The present invention extends the traditional model to break down the attributes into a workable and manageable solution. The method allows the reservationist to select individual attributes from a comprehensive list, in accordance with the guest requests, and is able to inform the guest as to the availability of each attribute for the entire stay or any part thereof. With this model the guest is informed that various accommodation requests can be met, such as a room with a king size bed, a room that is away from the ice machine and elevator, non-smoking, and on a high floor. Guests wanting certain attributes can also be advised of modifications to reservations as they become available, either through availability after arrival, or through a cancelled reservation.

Under prior art methods, a property has no way of easily knowing how many guests are requesting the same attributes. Further, certain attributes might be desirable for certain types of clients at certain times of the year. For example, a fireplace is much more desirable during the winter than the summer. Certain demand patterns can only be guessed at, without acquiring data, which the current methods do not adequately provide for.

One of the extended and advanced features of this method is that the data relating to all rooms, even those previously assigned, may be shuffled according to any desired factors within defined business rules. Rooms with the most desirable attributes and less desirable attributes may be shuffled with respect to one another, from high value to low value. Certain guests may also be given a different weight according to their perceived value to the User or Hotel. The guest who is a repeat guest, or a guest who traditionally books a large block of rooms for a company, will generally be treated in a different way than the guest who is only going to stay one or two nights. This system and method account for these types of weighted criteria, and will include the value of the guest and room attributes when determining a room assignment.

If a guest having a lower assigned weight requests certain attributes, the User making the reservation can check for availability for a matching room. This advanced method allows the system to determine a listing of available rooms from which assignments can be made. During the compiling of the rooms, attributes that are popular are given a higher weight than less popular or valuable attributes. Rooms that may qualify as a potential match for assignment will be positioned farther down the list of rooms matching the unrequested attributes, since the rooms are listed within the system according to attribute weight. If the system intends to provide a room with as low a weight as possible, and yet still match the Guest's requests, the low weighted Guest who is not specifically asking for a valued attribute will not be provided one inadvertently.

Conversely, a valuable or high weighted guest may make a request similar to that made by a lower weighted guest. The higher weighted guest will cause the room assignments to be made as to a higher weighted value on the room availability list within the system. This results in having more desirable rooms being made available for guests which the business has a higher desire to keep as a loyal guest. Therefore, a lower weighted guest may ask for a certain type of bed and view, and receive just that. The higher weighted guest may ask for the same type of bed and view, but because they have a higher weight, they will be assigned a room with additional features that are available. In this way, the more valuable guests will receive more valuable rooms, thus the business will maintain a higher level of satisfaction overall.

Accordingly, it is the intent of this invention to provide a means whereby Guests can make various requests as to room attributes and availability, with the User being able to ascertain all available rooms and various attributes associated with each room, so as to provide a room that most closely matches the requests.

It is a further intent of this invention to provide a means whereby certain room attributes are given a defining weight, as compared with other room attributes, with this defining weight affecting the manner in which the room is made available to potential Guests.

It is a further intent of this invention to provide a means whereby Guests themselves are given a proscribed weight, which relates to that Guest's desirability as a guest as compared to other guests. This weighted feature for Guests allows the business to respond more completely to certain Guest needs, as well as maximize room availability for certain features.

### DESCRIPTION OF FIGURES

FIG. 1 comprises a flow chart of the method steps for the invention.

### DETAILED DESCRIPTION OF THE INVENTION

A. Compilation of Data Sets

1. First Data Set—Room Availability

Prior to using this improved method, a first data set must be compiled. Several data sets are used within this improved method. The first data set compilation includes the rooms or units that are intended to be made available to Guests. This improvement has the ability to incorporate units within a single location, or may be used in conjunction with other locations, so as to create a master list of all rooms and properties to which they are associated.

An example of the first data set is shown in Table A below. Table A is a simplified version of a data set, and contains only four rooms. Any similarity in name to existing actual hotels is by coincidence only. A typical data set will have all rooms included, which generally comprises many more rooms. The available dates will include dates that the room is available to guests. Available dates, although shown as only a single time period, optimally has all time periods in the year in which the room is available.

TABLE A
Rooms available by dates

| Location | Room Number | Available Dates |
|---|---|---|
| Ocean Hotel | 1100 | Jan. 01, 2006-Jan. 01, 2007 |
| Ocean Hotel | 1101 | Feb. 01, 2006-May 05, 2006 |
| Ocean Hotel | 1102 | Mar. 01, 2006-Sep. 15, 2006 |
| Ocean Hotel | 1103 | Apr. 01, 2006-Mar. 02, 2007 |

The location of the rooms may be part of the data set, where multiple locations are included in a single data set. For example, the Ocean Hotel may have multiple rooms available, and the same company may also operate the Lake Hotel and the Hill Hotel. Therefore, a completed data set would include these hotels, as is shown in simplified form in Table B.

TABLE B
Total rooms available by dates

| Location | Room Number | Available Dates |
|---|---|---|
| Ocean Hotel | 1100 | Jan. 01, 2006-Jan. 01, 2007 |
| Ocean Hotel | 1101 | Feb. 01, 2006-May 05, 2006 |
| Ocean Hotel | 1102 | Mar. 01, 2006-Sep. 15, 2006 |
| Ocean Hotel | 1103 | Apr. 01, 2006-Mar. 02, 2007 |
| Lake Hotel | 1100 | Jan. 01, 2006-Jan. 01, 2007 |
| Lake Hotel | 1101 | Feb. 01, 2006-May 05, 2006 |
| Lake Hotel | 1102 | Mar. 01, 2006-Sep. 15, 2006 |
| Lake Hotel | 1103 | Apr. 01, 2006-Mar. 02, 2007 |
| Hill Hotel | 1100 | Jan. 01, 2006-Jan. 01, 2007 |
| Hill Hotel | 1101 | Feb. 01, 2006-May 05, 2006 |
| Hill Hotel | 1102 | Mar. 01, 2006-Sep. 15, 2006 |
| Hill Hotel | 1103 | Apr. 01, 2006-Mar. 02, 2007 |

2. Second Data Set—Room Attributes

A second data set comprising of attributes existing for various rooms is also compiled. This information is stored as an inventory of available attributes. Attributes may be anything that the user of this method finds to be the attractive features to offer guests. For example, the attributes will include such features as types of beds, views, location in relation to other locations, smoking preferences, and permanent features. Permanent features may include fireplaces, adjoining room doors, fixtures in rooms, and layout of rooms. Each attribute may have a sub list attribute, for example, the bathroom size may include large, medium and small sized bathrooms. This attribute list is an example of a small fraction of the possibilities.

The attributes are placed within said second data set, as shown in Table C. Table C is meant to be an illustrative list only, and not an exclusive list. There are many attributes that can be placed into the data set. Once a master data set is created, any hotel, motel, condominium association, or other similar business can use the data set to match up the attributes to their rooms. Exampled Codes are given in parenthesis.

TABLE C
Attribute types and codes

| Attribute | Sub1 | Sub2 | Sub3 |
|---|---|---|---|
| Room Type | Suite (Se) | Single (Sg) | w/Kitchenette (Ki) |
| Beds | King (K) | Queen (Q) | Double Beds (DD) |
| View | Ocean (O) | Mountain (M) | Courtyard (C) |
| Location | Close to | Close to | Away from |
| | Elevator (E+) | Pool (P+) | Pool (P−) |
| Permanent | Fireplace (FP) | Refrigerator (Rf) | Adjoining |
| Fixture | | | Room (+1) |
| Bathroom size | Large (B++) | Medium (B+) | Small (B) |
| Shower | Jacuzzi (J) | Shower (S) | Shower/tub (S/T) |

Once all attributes have been listed with each room to which they apply, a combined data set of rooms and attributes is available. Such a compilation is shown in Table D.

TABLE D
Compilation of rooms with attribute codes

| | | Available | |
|---|---|---|---|
| Location | Room Number | Dates | Attributes |
| Ocean | 1100 | Jan. 01, 2006-Jan. 01, 2007 | SE; Q; O; E+; Rf; B+; S/T |
| Hotel | | | |
| Ocean | 1101 | Feb. 01, 2006-May 05, 2006 | Sg; DD; M; P+; FP; |
| Hotel | | | |
| Ocean | 1102 | Mar. 01, 2006-Sep. 15, 2006 | Ki; K; C; P+; Rf; B++; J |
| Hotel | | | |
| Ocean | 1103 | Apr. 01, 2006-Mar. 02, 2007 | SE; Q; O; P−; Rf; B++; S/T |
| Hotel | | | |
| Lake Hotel | 1100 | Jan. 01, 2006-Jan. 01, 2007 | Sg; Q; M; P+; B; FP; S |
| Lake Hotel | 1101 | Feb. 01, 2006-May 05, 2006 | Sg; Q; M; P+; B++; FP; J |
| Lake Hotel | 1102 | Mar. 01, 2006-Sep. 15, 2006 | Ki; K; C; P+; Rf; B++; J |
| Lake Hotel | 1103 | Apr. 01, 2006-Mar. 02, 2007 | Ki; K; C; P+; Rf; B++; J |
| Hill Hotel | 1100 | Jan. 01, 2006-Jan. 01, 2007 | Ki; K; O; P+; Rf; B++; J |
| Hill Hotel | 1101 | Feb. 01, 2006-May 05, 2006 | SE; Q; O; P+; Rf; B++; S/T |
| Hill Hotel | 1102 | Mar. 01, 2006-Sep. 15, 2006 | SE; Q; O; E+; Rf; B+; S/T |
| Hill Hotel | 1103 | Apr. 01, 2006-Mar. 02, 2007 | Sg; Q; M; P+; FP; B+; S |

3. Third Data Set—Attribute Weight

A third data set, being a weighted data set, is also compiled. The weighted data set gives a value to each attribute. The weighted features may comprise a representative dollar value, or a simple positive or minus value. For example, attributes shown below in Table E may be given a weighted value as indicated. The attribute list and weighted values shown are exemplary only, and provided so as to properly explain their use within this improved method.

TABLE E
Attribute weights

| Sub1 | Weight | Sub2 | Weight | Sub3 | Weight |
|---|---|---|---|---|---|
| Suite (Se) | +2 | Single (Sg) | 0 | w/Kitchenette | +1 |
| | | | | (Ki) | |
| King (K) | +1 | Queen (Q) | 0 | Double Beds | −1 |
| | | | | (DD) | |
| Ocean (O) | +2 | Mountain (M) | +1 | Courtyard (C) | −1 |
| Close to | +1 | Close to Pool | −1 | Away from | +1 |
| Elevator | | (P+) | | Pool (P−) | |
| (E+) | | | | | |
| Fireplace | +2 | Refrigerator | +1 | Adjoining | +1 |
| (FP) | | (Rf) | | Room (+1) | |
| Large | +2 | Medium (B+) | +1 | Small (B) | 0 |
| (B++) | | | | | |
| Jacuzzi (J) | +2 | Shower (S) | +1 | Shower/tub | 0 |
| | | | | (S/T) | |

4. Fourth Data Set—Guest Weight

A secondary weighted data set is also able to be compiled, comprising the type of guest utilizing the services of the hotel or similar business. Guests who are repeat guests are given a greater weight than guests who only stay one time or infrequently. Guests who routinely reserve multiple rooms, such as a company who holds seminars at the hotel is also an entity or guest that the business wants to have a high level of guest satisfaction with. Table F shows an example of the weight attributable to guest types.

TABLE F
Guest weight

| Guest | Rooms reserved per year | Weight |
|---|---|---|
| Company V | 120 | +15 |
| Company W | 25 | it + 5 |
| Guest X | 6 | +2 |
| Guest Y | 2 | +1 |
| Guest Z | less than 1 | Guest |

Table F contains an example of the weight given to Company V, which holds seminars two times per year at the hotel, and utilizes a large amount of rooms and services each year. The hotel values this guest over other guests, and will always want the rooms provided for Company V to be as high a quality as is available for the price range. Company W also is a valued guest, though not as highly valued as Company V. Company W is still a higher valued guest than any individual guests shown in Table F. Guest X represents a business type guest who stays at the hotel every other month. Guest Y is a loyal guest, who stays at the hotel on their vacation, and may be in a membership or some other incentive program attached to the hotel. Guest Z is representative of a person who is staying at the hotel because they just happened to pick it, and not because they ascribe to any particular brand name hotel loyalty. Therefore, when the business has room available, the previously ascribed guest weight can affect which room is given to which guest. This can be done without denying a particular guest a desired feature. For example, if a guest does not request a particular feature, and that feature has a positive weight, there is a disincentive on the part of the hotel to assign a room with additional positively weighted attributes that were not requested. There may be guests, however, to which the Hotel may desire to upgrade their room as available, with the upgrade comprising a certain amount of positive attributes.

B. Compiling the First Three Data Sets

The data set relating to the rooms, the attributes and the total weight applicable to each attribute is compiled so that the total room value, in relation to other rooms available at the same location, or within the same company, can be compared to one another. As Table G indicates, the attributes for each room affect the comparative value of a particular room as compared to other rooms. Table G depicts two rooms with regard to their numerical order, and not to value. The complete data set used as an example for this invention and discussion thereof is contained in Table H. Table G comprises two of the rows shown in Table H.

The room number 1100 at the Lake Hotel has a weighted value of +3, while room number 1101 has a weighted value of +5. These rooms may have several similar attributes, such as a queen-size bed, a similar view, and a fireplace. Room 1101 has a larger bathroom and a Jacuzzi. These rooms may have similar prices when made available to guests, however room 1101 would likely be more attractive when compared to room 1100.

TABLE G
Partial listing of Rooms

| | | | | | |
|---|---|---|---|---|---|
| Lake | 1100 | Jan. 01, 2006- | Sg; Q; M; P+; | 0; 0; +1; −1; 0; | +3 |
| Hotel | | Jan. 01, 2007 | B; FP; S | +2; +1 | |
| Lake | 1101 | Feb. 01, 2006- | Sg; Q; M; P+; | 0; 0; +1; −1; | +5 |
| Hotel | | May 05, 2006 | B++; FP; J | +2; +2 | |

As Table H shows, the data set containing the rooms, listed attributes and weight of attributes would be made available to the business in the following manner. However, such a data set is only a small fraction of what many hotels have to offer as far as rooms and the facilities are concerned. Larger hotels have hundreds of rooms, and it would not be unreasonable to assume that 50 or more rooms might fit within a well-defined criteria as to attributes desired for a room by a guest.

TABLE H
Comprehensive table of Rooms, Attributes and Weight

| | | | | | Total |
|---|---|---|---|---|---|
| Location | Room No. | Dates | Attributes | Att. Weight | Weight |
| Ocean Hotel | 1100 | Jan. 01, 2006-Jan. 01, 2007 | SE; Q; O; E+; | +2; 0; +2; +1; | +7 |
| | | | Rf; B+; S/T | +1; +1; 0 | |
| Ocean Hotel | 1101 | Feb. 01, 2006-May 05, 2006 | Sg; DD; M; | 0; −1; +1; −1; | +1 |
| | | | P+; FP; | +2 | |
| Ocean Hotel | 1102 | Mar. 01, 2006-Sep. 15, 2006 | Ki; K; C; P+; | +1; +1; −1; −1; | +5 |
| | | | Rf; B++; J | +1; +2; +2 | |
| Ocean Hotel | 1103 | Apr. 01, 2006-Mar. 02, 2007 | SE; Q; O; P−; | +2; 0; +2; +1; | +8 |
| | | | Rf; B++; S/T | +1; +2; 0 | |
| Lake Hotel | 1100 | Jan. 01, 2006-Jan. 01, 2007 | Sg; Q; M; P+; | 0; 0; +1; −1; 0; | +3 |
| | | | B; FP; S | +2; +1 | |
| Lake Hotel | 1101 | Feb. 01, 2006-May 05, 2006 | Sg; Q; M; P+; | 0; 0; +1; −1; | +5 |
| | | | B++; FP; J | +2; +2 | |
| Lake Hotel | 1102 | Mar. 01, 2006-Sep. 15, 2006 | Ki; K; C; P+; | +1; +1; −1; −1; | +5 |
| | | | Rf; B++; J | +1; +2; +2 | |
| Lake Hotel | 1103 | Apr. 01, 2006-Mar. 02, 2007 | Ki; K; C; P+; | +1; +1; −1; −1; | +5 |
| | | | Rf; B++; J | +1; +2; +2 | |
| Hill Hotel | 1100 | Jan. 01, 2006-Jan. 01, 2007 | Ki; K; O; P+; | +1; +1; +2; −1; | +8 |
| | | | Rf; B++; J | +1; +2; +2 | |
| Hill Hotel | 1101 | Feb. 01, 2006-May 05, 2006 | SE; Q; O; P+; | +2; 0; +2; −1; | +6 |
| | | | Rf; B++; S/T | +1; +2; 0 | |
| Hill Hotel | 1102 | Mar. 01, 2006-Sep. 15, 2006 | SE; Q; O; E+; | +2; +1; +2; | +8 |
| | | | Rf; B+; S/T | +1; +1; +1; 0 | |
| Hill Hotel | 1103 | Apr. 01, 2006-Mar. 02, 2007 | Sg; Q; M; | 0; 0; +1; −1; | +4 |
| | | | P+; FP; B+; S | +2; +1; +1 | |

C. Availability of Rooms

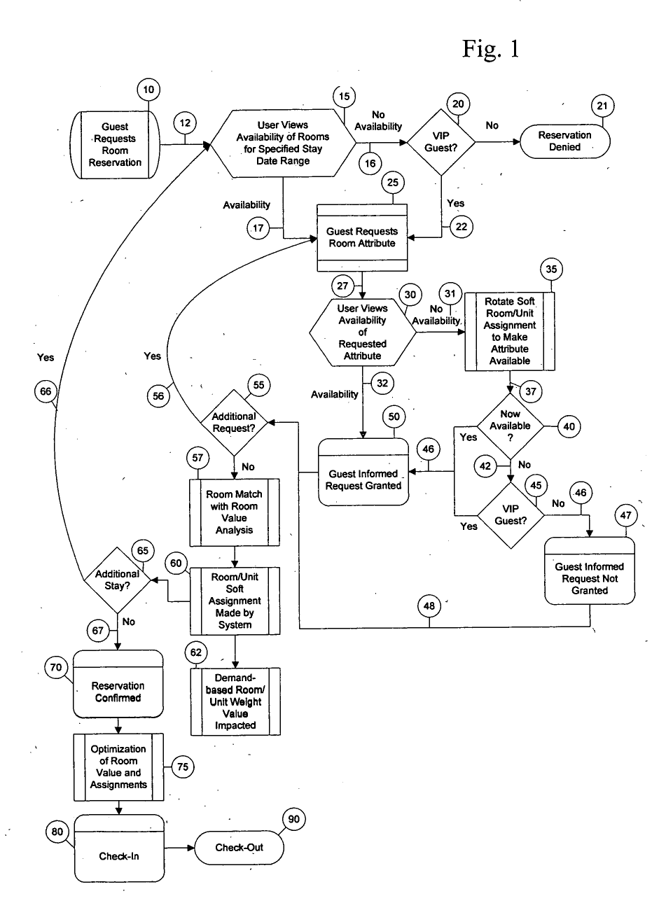

Referring now to FIG. 1, a guest contacts a hotel or other similar service 10, with the intent of renting a room between the dates of Jan. 15, 2006 though Jan. 18, 2006. These dates are for an example only. The request as to dates only will cause the database to determine how many rooms are available 17 or whether no rooms are available 16. The number of rooms available is provided to the User, which can then make a determination as to the availability of attributes requested in subsequent steps. Using the data set as shown in Table H, once queried as to rooms available for said above dates, the system will display that it has twelve rooms available. This is also shown as step 15 in FIG. 1, where the User views availability of rooms.

If rooms are determined to be available, as shown in step 17 in FIG. 1, then the various guest attributes 25 are requested. If it is determined that there are no available rooms, shown as step 16 in FIG. 1, then the guest status is determined as to whether or not that guest is considered a VIP by the User, shown as step 20 in FIG. 1. The determination of whether or not a guest is a VIP is dependent on the criteria established by the User. If the guest meets a certain weight, as defined in the fourth data set described and exampled in Table F, then that guest may be considered a VIP, and will be considered for a room regardless as to whether or not there are rooms available, shown as step 22 in FIG. 1. If the guest is not determined to be within the VIP qualification, then their status will not override the fact that there are no rooms currently available, and their reservation will be denied as shown in step 21 of FIG. 1.

D. Guest requests Room Attributes

The matching of attributes to guests in an optimal way allows the User or Hotel to benefit by making its best rooms always available to its best Guests, and meeting Guest requested needs on a higher rate of consistency. This method allows that to occur. If a Guest is determined to be suitable for reserving a room, the User will determine from the Guest what attributes the Guest is requesting, as shown as step 25 in FIG. 1. The requested attributes may be offered by the User as suggestions, or may simply be requested without prompting.

Unless an extremely detailed list of attributes is requested, it is likely that there may be multiple rooms that contain the requested attributes. Using Table I, in the situation where the rooms available would comprise rooms as such shown below, it would be likely that if a Guest selected a specific type of room, such as single (Sg), suite (SE) or kitchenette (Ki), that the Guest selection would likely define which room that Guest wanted. However, in a situation where the Guest is not particular as to any attribute of the room, other than they want a queen-size bed, both of these rooms are available at the Ocean Hotel and Lake Hotel. If a Guest does not care which facility they stay in, or what attributes the room ultimately has, the system makes the room assignment process with greater intelligence as it is done based on the goal of meeting more Guest requests. Clearly though, even if the rooms have the same base price, the room at the Ocean Hotel is more valuable overall to Guests than the one at the Lake Hotel, based on the attributes that have been given a certain weight. Therefore, unless the Guest specifies, the Hotel User will have the option of placing the Guest in whichever of the two rooms it desires. The Hotel may have the desire to place a particular Guest that it likes in the better room with the higher attribute weight. If the Guest does not even meet the requirements as a regular Guest, the Hotel is unlikely to have much future contact with the Guest, and the Hotel may place that Guest in the least valuable room it can.

E. User Views Available Rooms with Requested Attributes.

As shown in step 30 of FIG. 1, once the requested attributes are received by the User and put into the system, the system will show the number of rooms available that have those requested attributes when viewed for the time period. For example, where Guest wants a room on date of Jan. 15, 2006 through Jan. 18, 2006, Table I depicts what the system is aware of, even though the User may only be made aware that there are three rooms available. Since this is a simplistic example with so few rooms involved, this example does not show the problems that would exist if the viewing of the rooms included all possibilities in a business with 900 rooms. Therefore, in step 30, only the number of rooms is shown to the User. This could be modified to show more information in step 30 for a business with only a small amount of rooms.

TABLE I
Rooms qualifying as available for specific requested date

| | Room | Avail-able | | Weight of | Total |
|---|---|---|---|---|---|
| Location | Number | Dates | Attributes | Attributes | Weight |
| Hill Hotel | 1100 | Jan. 01, 2006-Jan. 01, 2007 | Ki; K; O;P+; | +1; +1; +2; −1; | +8 |
| | | | Rf; B++; J | +1; +2; +2 | |
| Ocean Hotel | 1100 | Jan. 01, 2006-Jan. 01, 2007 | SE; Q; O; E+; | +2; 0; +2; +1; | +7 |
| | | | Rf; B+; S/T | +1; +1; 0 | |
| Lake Hotel | 1100 | Jan. 01, 2006-Jan. 01, 2007 | Sg; Q; M; P+; | 0; 0; +1; −1; 0; | +3 |
| | | | B; FP; S | +2; +1 | |

Referring again to FIG. 1, when the rooms are displayed, either as to number of rooms available, or with additional information, the User views the available room according to the criteria specified as shown in step 30 of FIG. 1. In this example, dates are the sole criteria at this time. However, numerous criteria may be used, including attributes. If a room is available, then the Guest may request additional attributes.

F. Attribute Weight Modification

It should be understood that the attribute weight is subject to change according to the criteria set up by the business. For example, the Lake Hotel room shown in Table I has a set of attributes weighted as +3. However, in the wintertime, the same room may have a much increased value, due to the presence of a fireplace. Therefore, an attribute weight may be modified by the business according to perceived Guest desire, actual Guest desire shown by reservation trends, or by simply being modified by the business. The Lake Hotel room, shown in Table I may have a total weight of +3 during part of the year, but may jump to a much higher level such as a +9, if the fireplace is modified as an attribute weight from +2, to a +8. Likewise, in certain seasons, a fireplace may be a very undesirable feature for a room, or at least have no value to Guests. For example, during a hot season, a hotel might not even allow a fireplace to be used, nor would a Guest have any desire to use a fireplace during certain times of the year. Therefore, the fireplace attribute may be modified downward to 0 or even a negative number during certain times of the year. This will cause Lake Hotel room 1100 to vary as to total attribute weight as the fireplace attribute is given a −2 during the summer, a +2 in the fall, a +8 during the winter, and a 0 in the spring. Therefore, it should be understood that when rooms are shuffled according to attribute weight, that the shuffling and presentation of rooms in one particular order on one day, may be in a different order when reviewed on a second date. An example is shown below in Table J.

TABLE J
Attribute weight variation of fireplace and mountain view in winter

| | Room | Avail-able | | Weight of | Total |
|---|---|---|---|---|---|
| Location | Number | Dates | Attributes | Attributes | Weight |
| Hill Hotel | 1100 | Jan. 01, 2006-Jan. 01, 2007 | Ki; K; O; P+; | +1; +1; +2; −1; | +8 |
| | | | Rf; B++; J | +1; +2; +2 | |
| Ocean Hotel | 1100 | Jan. 01, 2006-Jan. 01, 2007 | SE; Q; O; E+; | +2; 0; +2; +1; | +7 |
| | | | Rf; B+; S/T | +1; +1; 0 | |
| Lake Hotel | 1100 | Jan. 01, 2006-Jan. 01, 2007 | Sg; Q; M; P+; | 0; 0; +4; −1; 0; | +12 |
| | | | B; FP; S | +8; +1 | |

Table K has had the data set of attributes modified so that the attributes are applicable to the time of the year. The fireplace is shown as an attribute modified and weighted on the dates of the reservation requested, rather than just on the date the query is made for room availability. The mountain view has also been modified, and applies to the Lake Hotel room as well, indicating that there is a higher public demand for a view of mountains with snow on them, than during the summertime, when the Ocean is a more sought after view.

The database determines that the rooms available must be shuffled according to Guest desires, and therefore the shuffling of the rooms occurs from that shown in Table J to Table K. During the wintertime, when the reservation is actually requested, the program and method has determined the more valuable room for the Guest, as well as reflecting a possible base price increase.

TABLE K
Showing seasonal attribute weight modifications for time of year,
showing modifications to weight for attributes of fireplace and mountain view in
wintertime.

| | Room | Avail-able | | Weight of | Total |
|---|---|---|---|---|---|
| Location | Number | Dates | Attributes | Attributes | Weight |
| Lake Hotel | 1100 | Jan. 01, 2006-Jan. 01, 2007 | Sg; Q; M; P+; | 0; 0; +4; −1; 0; | +12 |
| | | | B; FP; S | +8; +1 | |
| Hill Hotel | 1100 | Jan. 01, 2006-Jan. 01, 2007 | Ki; K; O; P+; | +1; +1; +2; −1; | +8 |
| | | | Rf; B++; J | +1; +2; +2 | |
| Ocean Hotel | 1100 | Jan. 01, 2006-Jan. 01, 2007 | SE; Q; O; E+; | +2; 0; +2; +1; | +7 |
| | | | Rf; B+; S/T | +1; +1; 0 | |

G. Granting Request for Room and Attributes

Referring again now to FIG. 1, when a User views the availability of requested attributes 30, the system will determine whether or not such attributes are available 32 or unavailable 31. If the attribute or attributes are determined to be available 32, the Guest is informed of this fact, and that a room is available to meet those requests, shown as step 50. The Guest may be queried as to whether or not they have any additional requests as to room attributes, shown as step 55 in FIG. 1. If the Guest informs the User that they have additional attribute requests 56, then that additional attribute request is added to those already made for a comprehensive attribute request list 25, and again that attribute list is presented to the system 27 so that the system can again determine whether or not there are rooms available and display this availability or unavailability to the User for viewing 30. This cycle of determining requested attributes and their availability may continue from steps 25-56 until there are no more requested attributes to consider.

Following a query of requested attributes 27, and the displaying of whether or not there are available rooms with such attributes 30, if the system determines that there is no availability of a room 31, then the system may rotate or shuffle the room assignments until a room matching the attribute request is located 35. If the room is located, a determination as to its availability is made 40. If the room can be made available by simply switching a Guest from a room then the room becomes available 46 and the Guest is informed that their request is granted 50.

It should be understood that a benefit of this novel method allows the system to effectively soft assign a room with the requested attributes, but to move the assignment whenever determined to be necessary. For example, if a Guest has requested a king size bed as the only requested attribute, and the soft assignment was made to a room with a king size bed and a Jacuzzi, and subsequently a request is made by a subsequent Guest for a Jacuzzi, the system will shuffle the first Guest to another room that has a king size bed without a Jacuzzi. Whereby the first Guest remains satisfied, and the second Guest is able to acquire a room with their requested attributes. In this way, there is an increase of customer satisfaction overall using this method.

H. Reassignment of Guests Based on Weight Using the Shuffled Room List.

1. Confirming of Reservation

Once all attribute requests have been considered and matched to an available room, as described above, a soft assignment is made for that Guest by the system 60. The User determines if there are additional stays associated with the reservation, 65, which comprises a need to have additional rooms reserved. The Guest can provide information about an additional stay 65, and if there are additional stays that must be considered 66, the process begins at step 15 as shown in FIG. 1. If all dates for the reservation have been approved, and no additional stay is conveyed 67, then a reservation can be confirmed. The reservation will remain in the soft mode until the Guest actually checks in 80. The system will continuously optimize the room value and assignments, shown as step 75 which is discussed further below. In this step 75, Guests can be reassigned to new rooms at any time that the system determines it to be appropriate. This shuffling of soft room assignments 75 is done continuously until the Guest checks in, but the Guest is unaware of this occurring because the Guest has not yet been informed of their specific room assignment.

It is possible for a Guest to need a new room assignment after check in 80 up to time of check out 90. In this situation, the User may manually select a new room assignment, based on the situation, and using the data available from the system.

In a situation where an attribute is requested 40, and has been determined to not be available 42, then again the system makes a determination as to whether or not the requesting Guest qualifies as a VIP, as shown as step 45 in FIG. 1. If a Guest is not determined to be a VIP 46, then that Guest is informed that their room request with attributes cannot be fulfilled, and additional requests or options are requested 55. The additional requests are conveyed to the system 56 to begin the analysis of room availability anew.

2. Taking Guest status as VIP into consideration

If the Guest is determined to be a VIP in step 45, and where that VIP Guest will take priority over another soft room assignment, the room requested will then be considered available 46, and the Guest will be informed that their request is granted 50, subject to any additional requests 55 that are again offered 56 to be considered.

Referring again to Table F, a sampling of Guests has been assigned the weight that is appropriate to the amount of business that each Guest generates with the Hotel over a certain time period. The weight reflects the respective value of the Guest to the Hotel, and allows the system to assign rooms and give benefits or deny benefits to a Guest based on their perceived value to the User, and the desire of the User to maintain a certain level of Guest satisfaction.

3. Modifying Room Assignments Prior to Guest Arrival

Hotels often find themselves in the position where they must modify room assignments in order to accommodate preferred Guests, also known as VIP Guests. For example, if Guest Z and Company W are competing for the same room, the hotel will want to ensure the Company W is the Guest that receives the room. While the hotel may value the potential business that Guest Z will bring, it does not wish to deny an ongoing profitable relationship between it and Company W. Therefore, even in a situation where a hotel has inadvertently or purposely overbooked their rooms, they might be willing to cancel a reservation for a Guest Z and make that room available, in order to accommodate Company V or W, which seeks a reservation subsequent to Guest Z.

The criteria of when to allow one Guest or Guests to be moved and replaced by another Guest or Guests of a different weight, is dependent on the system's criteria. For purposes of explanation, Table F represents five examples of the types of Guests that a hotel will deal with. It should be understood that the number or criteria of Guests or companies is typically much more comprehensive than shown in Table F. Further, the weight given for each company or Guest is representative for this example, and should not be inferred as a limiting factor or defining value that must be followed in order for this method to work properly.

Referring now also to Table L, a sampling of all available rooms is shown. The rooms are displayed according to attribute weight. Guest assignments are shown as having been made by the system, as shown in FIG. 1, number 60. These can be considered “soft” room assignments. These assignments are made in accordance with room availability, and are subject to modification as needed.

In Table L, Company W has requested and received a soft assignment for a suite as indicated as Ocean Hotel room number 1103. The property location is irrelevant to Company W. Following the progression shown in FIG. 1, the reservation for Company W was made as a “soft” assignment 60. Since Company W is a valuable Guest, the soft assignment was made for the most valuable room according to attribute weight that still fulfilled the attribute criteria request. If a suite is the sole attribute request made by Company W, the system will review the rooms available, and will note that there are four rooms that fit this criteria. Since this Guest is valued above-average, the system will determine that a better room is appropriate.

The assignment made for Company W is able to be compared with the assignment made for Guest X. In this situation, both Company W and Guest X have made requests for a suite as the only criteria attribute requested. The assignments were made for different rooms, because Guest X was determined by the system to be an average or below average Guest, according to the weight previously assigned to Guest X. Therefore, although the requests were the same, a higher weighted Guest (Company W) is assigned a higher value room on the shuffled room available listing, while the less valuable Guest (Guest X), as comparative to Company W was assigned the less valuable room containing the same desired attributes.

The assignment of rooms as to value is not only appropriate for Guests that are considered valuable, but it also is applicable for Guests that have a below average weight. In this situation, when the soft assignment is made by the system 60, a less valuable Guest is assigned a room that fits the necessary criteria as best as possible, but the system selects a lower valued room concerning the attributes.

3. Competing Room/Attribute Requests

As it is shown in Table L below, Guests Y and Z have made a request for any single room, and for purposes of this explanation Guest Y has also requested a queen-size bed as an additional attribute. When the soft assignment is made 60, Guest Z is given a soft room assignment with the system looking first at the rooms having the fewest attributes by weight. Accordingly, where Guest Z has been given the lowest value weight, the lowest weighted rooms are assigned. Where both Guest Y and Z have requested a single room with a Queen bed and a fireplace, Guest Y is given the more valuable room according to weight than Guest Z.

TABLE F
(Repeat of Table F)

| Guest | Rooms reserved per year | Weight |
|---|---|---|
| Company V | 120 | +15 |
| Company W | 25 | +5 |
| Guest X | 6 | +2 |
| Guest Y | 2 | +1 |
| Guest Z | less than 1 | 0 |

TABLE L
Guest assignment according to Guest weight and attribute weight

| | Room | Avail-able | | Weight of | Total | Guest |
|---|---|---|---|---|---|---|
| Location | Number | Dates | Attributes | Attributes | Weight | Assign. |
| Ocean | 1103 | Apr. 01, 2006-Mar. 02, 2007 | SE; Q; O; | +2; 0; +2; | +8 | Co. W |
| Hotel | | | P−; Rf; | +1; +1; +2; 0 | | (weight = 5) |
| | | | B++; S/T | | | |
| Hill Hotel | 1100 | Jan. 01, 2006-Jan. 01, 2007 | Ki; K; O; | +1; +1; +2; | +8 | |
| | | | P+; Rf; | −1; +1; +2; | | |
| | | | B++; J | +2 | | |
| Hill Hotel | 1102 | Mar. 01, 2006-Sep. 15, 2006 | SE; Q; O; | +2; +1; +2; | +8 | |
| | | | E+; Rf; B+; | +1; +1; +1; 0 | | |
| | | | S/T | | | |
| Ocean | 1100 | Jan. 01, 2006-Jan. 01, 2007 | SE; Q; O; | +2; 0; +2; | +7 | Guest. X |
| Hotel | | | E+; Rf; B+; | +1; +1; +1; 0 | | (weight = 2) |
| | | | S/T | | | |
| Hill Hotel | 1101 | Feb. 01, 2006-May 05, 2006 | SE; Q; O; | +2; 0; +2; −1; | +6 | |
| | | | P+; Rf; | +1; +2; 0 | | |
| | | | B++; S/T | | | |
| Lake Hotel | 1101 | Feb. 01, 2006-May 05, 2006 | Sg; Q; M; | 0; 0; +1; −1; | +5 | |
| | | | P+; B++; | +2; +2 | | |
| | | | FP; J | | | |
| Lake Hotel | 1102 | Mar. 01, 2006-Sep. 15, 2006 | Ki; K; C; | +1; +1; −1; −1; | +5 | |
| | | | P+; Rf; | +1; +2; | | |
| | | | B++; J | +2 | | |
| Lake Hotel | 1103 | Apr. 01, 2006-Mar. 02, 2007 | Ki; K; C; | +1; +1; −1; −1 | +5 | |
| | | | P+; Rf; | +1; +2; | | |
| | | | B++; J | +2 | | |
| Ocean | 1102 | Mar. 01, 2006-Sep. 15, 2006 | Ki; K; C; | +1; +1; −1; −1; | +5 | |
| Hotel | | | P+; Rf; | +1; +2; | | |
| | | | B++; J | +2 | | |
| Hill Hotel | 1103 | Apr. 01, 2006-Mar. 02, 2007 | Sg; Q; M; | 0; 0; +1; −1; | +4 | Guest. Y |
| | | | P+; FP; B+; S | +2; +1; +1 | | (weight = 1) |
| Lake Hotel | 1100 | Jan. 01, 2006-Jan. 01, 2007 | Sg; Q; M; | 0; 0; +1; −1; | +3 | Guest. Z |
| | | | P+; B; FP; S | 0; +2; +1 | | (weight = 0) |
| Ocean | 1101 | Feb. 01, 2006-May 05, 2006 | Sg; DD; M; | 0; −1; +1; −1; | +1 | Guest. Z |
| Hotel | | | P+; FP; | +2 | | (weight = 0) |

The soft assignment is always subject to change. Therefore, if Guest Y was the first Guest to make a request for a single queen-size room with a fireplace, because this Guest does not have a remarkable weight classification, the system may soft assign the least desirable room as to weight for this Guest. Therefore, Guest Y would be soft assigned Lake Hotel room 1100, as shown in Table M

TABLE M
Soft assignment of Guest Y

| | | | | | | |
|---|---|---|---|---|---|---|
| Hill Hotel | 1103 | Apr. 01, 2006-Mar. 02, 2007 | Sg; Q; M; | 0; 0; +1; −1; | +4 | |
| | | | P+; FP; B+; S | +2; +1; +1 | | |
| Lake Hotel | 1100 | Jan. 01, 2006-Jan. 01, 2007 | Sg; Q; M; | 0; 0; +1; −1; | +3 | Guest. Y |
| | | | P+; B; FP; S | 0; +2; +1 | | (weight = 1) |
| Ocean | 1101 | Feb. 01, 2006-May 05, 2006 | Sg; DD; M; | 0; −1; +1; −1; | +1 | Guest. Z |
| Hotel | | | P+; FP; | +2 | | (weight = 0) |

If a subsequent Guest categorized as Guest Z makes the same request for a room as did Guest Y, the system may simply assign Hill Hotel room 1103 to the new Guest Z as a soft assignment. However, the method of assigning rooms may also be in accordance to Guest weight. Since Guest Y has a greater weight than Guest Z, the soft assignment for Guest Y may be moved up to the next rated room, as shown in Table N.

TABLE N
Reassignment of Guest Y

| | | | | | | |
|---|---|---|---|---|---|---|
| Hill Hotel | 1103 | Apr. 01, 2006-Mar. 02, 2007 | Sg; Q; M; | 0; 0; +1; −1; | +4 | Guest. Y |
| | | | P+; FP; B+; S | +2; +1; +1 | | (weight = 1) |
| Lake Hotel | 1100 | Jan. 01, 2006-Jan. 01, 2007 | Sg; Q; M; P+; | 0; 0; +1; −1; | +3 | |
| | | | B; FP; S | 0; +2; +1 | | |
| Ocean | 1101 | Feb. 01, 2006-May 05, 2006 | Sg; DD; M; | 0; −1; +1; −1; | +1 | Guest. Z |
| Hotel | | | P+; FP; | +2 | | (weight = 0) |

The soft reassignment of Guest Y to Hill Hotel Room 1103 leaves a room with a lesser weight score for a Guest Z weight to receive a soft assignment for. The system then reassigns Lake Hotel room 1100 to the new Guest Z, since that is the lowest weighted room that meets the attribute requests. The reassignment is made as shown in Table O.

TABLE O
Assignment of second Guest Z

| | | | | | | |
|---|---|---|---|---|---|---|
| Hill Hotel | 1103 | Apr. 01, 2006-Mar. 02, 2007 | Sg; Q; M; | 0; 0; +1; −1; | +4 | Guest. Y |
| | | | P+; FP; B+; S | +2; +1; +1 | | (weight = 1) |
| Lake Hotel | 1100 | Jan. 01, 2006-Jan. 01, 2007 | Sg; Q; M; | 0; 0; +1; −1; | +3 | Guest. Z |
| | | | P+; B; FP; S | 0; +2; +1 | | (weight = 0) |
| Ocean | 1101 | Feb. 01, 2006-May 05, 2006 | Sg; DD; M; | 0; −1; +1; −1; | +1 | Guest. Z |
| Hotel | | | P+; FP; | +2 | | (weight = 0) |

This method also allows the system to make accommodations between preferred Guests, where one Guest is a higher weighted Guest than another. If the previous Guest soft assignments have been made as shown in the table below, and a subsequent Guest Company V makes a specific request for a room that is a Suite, queen-size bed, Ocean view that is also close to an elevator, its criteria of attributes will match the only available room with those qualifications that has already been soft assigned to Guest X. In a situation where Guest X has made the same type of attribute requests, the system parameters will decide whether or not to reassign that room to Company V. If Company V has a much higher weighted rating than Guest X, the system may soft reassign Guest X so that Company V may be soft assigned that room. This may be done and parameters established by the User to give the Guest weight the overall priority. The User may also have defined that a Guest that has a minimum weight will always dislodge a Guest with a lower weight. Table P depicts the system's soft room assignments for Company W and Guest X, prior to Company V's request for a room.

TABLE P
Soft room assignments for Co. W and Guest X

| | Room | Available | | Weight of | Total | Guest |
|---|---|---|---|---|---|---|
| Location | Number | Dates | Attributes | Attributes | Weight | Assign. |
| Ocean | 1103 | Apr. 01, 2006-Mar. 02, 2007 | SE; Q; O; | +2; 0; +2; | +8 | Co. W |
| Hotel | | | P−; Rf; | +1; +1; +2; 0 | | (weight = 5) |
| | | | B++; S/T | | | |
| Hill Hotel | 1100 | Jan. 01, 2006-Jan. 01, 2007 | Ki; K; O; | +1; +1; +2; | +8 | |
| | | | P+; Rf; | −1; +1; +2; | | |
| | | | B++; J | +2 | | |
| Hill Hotel | 1102 | Mar. 01, 2006-Sep. 15, 2006 | SE; Q; O; | +2; +1; +2; | +8 | |
| | | | E+; Rf; B+; | +1; +1; +1; 0 | | |
| | | | S/T | | | |
| Ocean | 1100 | Jan. 01, 2006-Jan. 01, 2007 | SE; Q; O; | +2; 0; +2; | +7 | Guest. X |
| Hotel | | | E+; Rf; B+; | +1; +1; +1; 0 | | (weight = 2) |
| | | | S/T | | | |
| Hill Hotel | 1101 | Feb. 01, 2006-May 05, 2006 | SE; Q; O; | +2; 0; +2; −1; | +6 | |
| | | | P+; Rf; | +1; +2; 0 | | |
| | | | B++; S/T | | | |

Since the room has been made as a soft assignment, the Guest is unaware of the specific room number they will receive. If the system decides that Company V usurps Guest X, the system will review and locate the next available room having matching requested attributes as was previously given by Guest X. Guest X is reassigned to the next matching room with the highest weight, in this case Hill Hotel room 1101, as shown in Table Q. Company V is then soft assigned to room Ocean Hotel room 1100, as shown in Table Q. This reassignment of rooms to Guests depending on their given weight may occur in a chain reaction, and multiple rooms that were previously soft assigned may be reassigned in order to accommodate the Guests desired by the User.

TABLE Q
Assignment of room to Company V

| | Room | Available | | Weight of | Total | Guest |
|---|---|---|---|---|---|---|
| Location | Number | Dates | Attributes | Attributes | Weight | Assign. |
| Ocean | 1103 | Apr. 01, 2006-Mar. 02, 2007 | SE; Q; O; | +2; 0; +2; | +8 | Co. W |
| Hotel | | | P−; Rf; | +1; +1; +2; 0 | | (weight = 5) |
| | | | B++; S/T | | | |
| Hill Hotel | 1100 | Jan. 01, 2006-Jan. 01, 2007 | Ki; K; O; | +1; +1; +2; | +8 | |
| | | | P+; Rf; | −1; +1; +2; | | |
| | | | B++; J | +2 | | |
| Hill Hotel | 1102 | Mar. 01, 2006-Sep. 15, 2006 | SE; Q; O; | +2; +1; +2; | +8 | |
| | | | E+; Rf; B+; | +1; +1; +1; 0 | | |
| | | | S/T | | | |
| Ocean | 1100 | Jan. 01, 2006-Jan. 01, 2007 | SE; Q; O; | +2; 0; +2; | +7 | Co. V |
| Hotel | | | E+; Rf; B+; | +1; +1; +1; 0 | | (weight = 15) |
| | | | S/T | | | |
| Hill Hotel | 1101 | Feb. 01, 2006-May 05, 2006 | SE; Q; O; | +2; 0; +2; −1; | +6 | Guest. X |
| | | | P+; Rf; | +1; +2; 0 | | (weight = 2) |
| | | | B++; S/T | | | |

I. Optimizing Room Value and Assignments

The system attempts to optimize the assignments of the higher weighted rooms for the most desirable Guests, and the less desirable rooms with the less desirable Guests. As historical data is gathered, patterns emerge which are used to increase weight values for high demand attributes. As these weight values are updated, room assignments are shuffled to accommodate the new values, as is shown in step 75 in FIG. 1.

Prior to accurately matching rooms with Guests, it is necessary that the attributes be given proper weights. The system may start out with assumed attribute weights. The attribute weights may be modified through Guest behavior and history.

Referring to FIG. 1, the data relating to attributes that have been specifically requested, is compiled so that each attribute is discernible with regard to the frequency and time periods in which the attribute was specifically requested. This compilation follows the soft assignment that has been made by the system 60, with the compilation of information generated 62 so that it can be reviewed so as to more accurately reflect the realistic and actual weight given to each attribute. Each attribute may be compiled as to days requested for each individual attribute and room per day. As Table R shows below, the four attributes listed have been determined as to frequency and the actual date in which the request was made known. Each attribute is provided with its own data with regard to days requested. As stated above, the attributes are unlimited as to type. For purposes of the discussion in this matter, only four attributes will be considered. As is shown in the following table, each time a particular attribute was requested, a separate line was created in which the days requested for that particular attribute for a specific Guest were quantified. For purposes of explanation, the days requested are given numerically from 1 to 365. Utilizing the data relating to the specific days requested for each attribute allows more than simply determining what is the most desirable attribute over the course of a year. By determining the specific days that each attribute is requested, additional data is provided in which the desirability of a particular attribute may be higher during certain times of the week, and lower during other times of the week. Knowing which attributes are more popular on certain days of the week allows the system to determine more specifically the value of a particular attribute with regard to which day it has been requested. This data is also applicable for time periods such as various weeks or even months in which a particular attribute has an increased weight applicable to it. For simplicity, the examples shown here cover only four attributes, and a small number of days in which each attribute was requested.

TABLE R
Showing attribute requests as to days

| Attribute | Day Requested |
|---|---|
| Tub/Shower | 112, 113, 114 |
| Jacuzzi | 14, 15 |
| King | 25, 26, 27, 28 |
| Tub/Shower | 117, 118 |
| Tub/Shower | 111, 112, 113, 114 |
| Queen | 178 |
| Queen | 177, 178, 179 |
| Tub/Shower | 308, 309 |
| King | 27, 28 |
| Tub/Shower | 114, 115 |
| King | 116, 117, 118 |

The data, regarding the frequency and time period in which the attribute was requested, is compiled so that each particular type of attribute request is given its own line of information, so that repeating time periods are able to be determined, as well as the frequency for the attribute desirability. As the table below shows, using the table above to give an overview of the frequency and time periods in which a particular attribute has been requested is provided. With the data provided in this manner, overlapping of requests for a particular attribute indicates a higher frequency or demand for that attribute in the overlapped time period.

Using the exampled data for the demand pattern regarding the tub/shower, it is clear that a three day period has a higher incident of that attribute having been requested as compared to other days of the week. Where days 112-114 reflect weekends, and where the majority of days requested for the attribute of the tub/shower are done on the weekends, that particular attribute can be determined to have an increased weight according to consumer demand on the weekend more than during the week.

TABLE S
Total days for each attribute request to show demand pattern

| | Number of Days | |
|---|---|---|
| Attribute | Requested | Demand Pattern |
| Tub/Shower | 12 | 111, 112, 112, 113, 113, 114, 114, 114, |
| | | 115, 308, 309 |
| Jacuzzi | 2 | 14, 15 |
| King | 9 | 25, 26, 27, 27, 28, 28 |
| Queen | 4 | 177, 178, 178, 179 |

Once the demand pattern is established, the weight of the attribute is compared with the demand pattern. If the demand pattern shows an increase or decrease in requests made by Guests during a particular time period, the demand pattern analysis will cause the system to modify the weight. As shown in Table T below, because the tub/shower was requested so often on Friday, Saturday and Sunday, but rather infrequently during the week, the weight of the tub/shower is modified to reflect the increased demand on the weekends. As the table below shows, the previous weight for the tub/shower was 0. However the analysis of the consumer demand pattern indicates that the weekends have a very high incident of that attribute being requested. Therefore, the system will analyze the demand patterns and can modify the weight for a particular attribute to reflect the increased demand pattern on the weekends. As the table below shows, a modified weight increases from 0 to +2 on the weekends. Since there is insufficient consumer demand pattern to indicate that the weekdays have a demand pattern that acquires modification of weight, the modified weight remains unchanged.

TABLE T
Value impacted modification

| Attribute | Previous Weight | Demand Pattern | Modified Weight |
|---|---|---|---|
| Tub/Shower | 0 | Fri, Sat, Sun - | M thru Th - 0; |
| | | high | F thru Sun - +2 |
| Jacuzzi | +2 | low | +1 |
| King | +2 | Fri, Sat - high | Sun through Th - +1 |
| | | | Fri through Sat - +3 |
| Queen | +1 | Fri, Sat - med | Sun through Th - +1 |
| | | | Fri through Sat - +2 |

This method also has significant use with any type of leasing business concern, such as condominium rentals, or any business that has the ability to offer a service or rental facility that belongs to a group in which there are multiple attributes to consider. This method offers the ability to inventory and track all attributes in a dissected manner. Prior art only allowed a room or unit to be considered as a total attribute combination, and the attributes were not able to be singled out to match customer requests, irrespective of other attributes. Accordingly, this method should not be construed to be limited to hotels, and the word “hotel” should not be construed as a limitation to that type of business only, but would apply to any type of business concern that rents or leases space or units for intervals of time, where said space or units have attributes that partially define their value. Likewise, the word “room” should not be interpreted as an individual room, but should be understood as being a descriptive word of any type of space or unit that is being leased, rented or sold.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

I claim:

1. A method of using a system to assist in assigning rooms to Guests, comprising:
a. compiling a database comprising of at least one data set containing room availability, and one data set containing room attributes, and one data set containing attribute weight;
b. determining and inventorying the attributes requested by a Guest;
c. shuffling all rooms in the database to reflect value associated with the attributes;
d. assigning the Guest an available room that most closely matches the attribute request that has the lowest attribute weight.

2. A method of using a system to assist in assigning rooms to Guests, as recited in claim 1, in which the Guest is assigned a weight, depending on the perceived value of the Guest by the User, and where the Guest is given priority to available rooms depending on the weight of the Guest as compared with other Guests.

3. A method of using a system to assist in assigning rooms to Guests, as recited in claim 1, in which:
a. the Guest is assigned a weight that is lower, rather than higher, as compared with other Guests;
b. assigning a room to the Guest as a soft assignment, where the room only contains those attributes requested by the Guest;
c. shuffling all rooms by the system in relation to their respective attributes, and locating all rooms that are available which also contain the attributes requested by the Guest; and
d. reassigning the Guest to a different room prior to check in, where the reassigned room has a lower attribute weight.

4. A method of using a system to assist in assigning rooms to Guests, as recited in claim 1, in which:
a. the Guest is assigned a weight that is higher, rather than lower, as compared with other Guests;
b. assigning a room to the Guest as a soft assignment, where the room only contains those attributes requested by the Guest;
c. shuffling all rooms by the system in relation to their respective attributes, and locating all rooms that contain the attributes requested by the Guest; and
d. reassigning the Guest to a different room prior to check in, where the reassigned room has a higher attribute weight.

5. A method of using a system to assist in assigning rooms to Guests, as recited in claim 1, in which:
a. the Guest is assigned a weight that is respective to other Guests;
b. shuffling all rooms in relation to their respective attributes, and locating all rooms which also contain the attributes requested by the Guest; and
c. determining whether or not any rooms are available for assignment, in which the determination considers the weight of the Guest as compared to other Guests having had rooms previously assigned;
d. assigning the Guest a room that matches the Guest's requested attributes, where if the Guest is a high weighted Guest, they will replace a lower weighted Guest, or if the Guest has a lower or equal respective weight to all other Guests previously assigned, that they will be assigned a room only if a room is currently unassigned.

6. A method of using a system to assist in assigning rooms to Guests, as recited in claim 1, in which the room attribute weight data set is modified as to value, by the system through analysis of historical data.

7. A method of using a system to assist in assigning rooms to Guests, as recited in claim 1, in which the Guest weight data set is modified as to value for each Guest, by the system through analysis of historical data.

8. A method of displaying attribute availability in which each attribute is represented singularly, irrespective of the other attributes associated with a given room, comprising the following steps:
a. defining the types of attributes which exist for all rooms;
b. defining the attributes that are associated with each individual room, and compiling this information into a data set;
c. querying the data set by a system as to a specific attribute or combination of attributes; and where the system retrieves all rooms having the attribute or attribute combination requested; and
d. displaying the number of rooms retrieved.

9. A method of optimizing room value and assignments as a continuous process, comprising
a. compiling a database comprising of at least one data set of room attributes;
b. defining the established weight of each room attribute;
c. determining the recent frequency of each attribute selection made by Guests within a defined period of time as a demand pattern;
d. comparing the established weight of each attribute with the demand pattern of each attribute; and
e. modifying the established weight of each attribute positively or negatively, based on the difference in the established attribute weight to the demand pattern for each attribute selection.

10. A method of optimizing room value and assignments as a continuous process, as recited in claim 9, in which the frequency of each selection made also includes a determination as to the specific days that the attribute was requested.
